(19) United States
(12) Patent Application Publication
(10) Pub. No.: US 2006/0218124 A1
(43) Pub. Date: Sep. 28, 2006

(54) Performance of a data processing apparatus

(75) Inventors: Barry Duane Williamson, Austin, TX (US); Stephen John Hill, Austin, TX (US); Glen Andrew Harris, Austin, TX (US); David James Williamson, Austin, TX (US)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/085,254

(22) Filed: Mar. 22, 2005

(51) Int. Cl. G06F 17/30

(52) U.S. Cl. 707/2

(57) ABSTRACT

Techniques for improving the performance of a data processing apparatus are disclosed. The data processing apparatus is operable to execute a data access instruction which causes a first plurality of data items to be transferred between registers and memory. The data processing apparatus is also operable to transfer a second plurality of data items between the registers and the memory in each processing cycle. The data processing apparatus comprises: decode logic operable in response to receipt of one of the data access instruction to determine a number of reserved processing cycles to be reserved for the execution of the data access instruction, the number of reserved processing cycles being determined to be a number of processing cycles which would enable greater than the first plurality of data items to be transferred in those reserved processing cycles. Hence, a greater number of processing cycles are reserved than are strictly necessary. Whilst it will be appreciated that this may have a slight performance impact on data access instructions which take the minimum possible time to execute, reserving more processing cycles than should be necessary helps to ensure that for those data access instructions which take longer to execute, a replay mechanism is unlikely to need to be invoked. It has been found that such an approach can significantly improve the performance of the data processing apparatus.

### FIELD OF THE INVENTION

The present invention relates to techniques for improving the performance of a data processing apparatus.

### BACKGROUND OF THE INVENTION

In a conventional pipelined data processing apparatus, in the event that a dependency between instructions is determined during the execution of those instructions, a stall signal is propagated back through the pipeline in order to stall succeeding instructions. It is important to stall the succeeding instructions because, as a result of the dependency, one or more of these instructions may need to use the result of a preceding instruction and that result may not yet be available.

Whilst stalling ensures that instructions only ever execute with valid data, the determination that there is a dependency between instructions will usually be made late in the processing cycle. Hence, the time available to propagate the stall signal back through the pipeline is relatively short. Also, because there is little time available, the stall signal must be driven hard.

It will be appreciated that a problem with this approach is that as the processing speed of the pipeline increases, the time available to propagate the stall signal reduces further until it becomes a limiting factor in the processing speed of the data processing apparatus.

In order to alleviate this problem, a statically-scheduled technique has been adopted. In the statically-scheduled technique, the instructions are only ever issued in order and a scoreboard is provided. Prior to issuing each instruction, a prediction is made of when resources (such as registers or processing logic, etc.) will required to be available for use by the instruction and those resources are effectively reserved by updating the relevant entries associated with those resources in the scoreboard. The scoreboard can then be referred to prior to issuing succeeding instructions to ensure that those succeeding instructions are not issued for execution at a time which would require the succeeding instruction to access a register or use logic which has not yet been updated or which is already being used. If the scoreboard indicates that a conflict will occur then the succeeding instructions is delayed from being issued until a prediction is made that the resources will be available at the required time.

However, the scoreboard technique relies on accurate predictions relating to the availability of the resources. In the event that, for whatever reason, it transpires that resources are not available for use by an instruction at the time predicted then the instruction will execute regardless and will generate invalid data.

To deal with any invalid execution, a determination is made by the data processing apparatus, prior to any architectural state associated with the executed instruction being committed, as to whether the instruction has executed validly (i.e. the instructions has been executed correctly or completed without error and so it is safe to retire). If an instruction executes validly then the architectural state is committed and the instruction retired. However, in the event it is determined that an instruction has not executed validly then a replay mechanism is activated.

The replay mechanism uses a replay queue which stores details of instructions that have been issued for execution but have not yet retired. When an error occurs, the pipeline is reset and the instructions from the replay queue are issued (in their original sequence) back through the pipeline.

Hence, by using a scoreboard, it can be assumed that once an instruction is issued its progress is considered to be deterministic since it can be assumed that all the data and resources required by that instruction will be available at the appropriate time to enable the instruction to execute validly.

It will be appreciated that the statically-scheduled approach overcomes the drawbacks of having to propagate the stall signal back through the pipeline because the decision as to whether there is a dependency between instructions can be predetermined prior to the instruction ever being issued for execution. Thus, using the scoreboard technique enables a determination to be made much earlier in the processing cycle as to whether the instruction needs to be delayed. It will be appreciated that this approach can improve the performance of the data processing apparatus.

However, such statically-scheduled data processing apparatus can exhibit poor performance under certain conditions.

It is desired to provide an improved technique for improving the performance of such a statically-scheduled data processing apparatus.

### SUMMARY OF THE INVENTION

Viewed from a first aspect, the present invention provides a data processing apparatus operable to execute a data access instruction which causes a first plurality of data items to be transferred between registers and memory, the data processing apparatus being operable to transfer a second plurality of data items between the registers and the memory in each processing cycle, the data processing apparatus comprising: decode logic operable in response to receipt of one of the data access instruction to determine a number of reserved processing cycles to be reserved for the execution of the data access instruction, the number of reserved processing cycles being determined to be a number of processing cycles which would enable greater than the first plurality of data items to be transferred in those reserved processing cycles.

The present invention recognises that the performance of a data processing apparatus when performing data access instructions can be poor. This poor performance can be due to an inappropriate number of processing cycles being reserved for executing the data access instruction. Reserving an inappropriate number of processing cycles may result in the replay mechanism having to be invoked. The performance overhead of invoking replay mechanism is typically high. For example, a typical data access may take a number of processing cycles, whereas invoking the replay mechanism may take many times more than this. Hence, the present invention recognises that in order to reduce the number of replays that need to be performed, the prediction of when execution of an instruction will cause various resources to be available for succeeding instructions needs to be as accurate as possible. If the prediction is overly optimistic, then the number of replays which occur will increase, which could adversely affect overall performance.

Accordingly, decode logic is provided which causes a number of processing cycles to be reserved for the execution of each data access instruction. The number of processing cycles reserved is determined to be that number which would enable more than the first plurality of data items to be transferred in that number of reserved processing cycles. Hence, a greater number of processing cycles are reserved than are strictly necessary. Whilst it will be appreciated that this may have a slight performance impact on data access instructions which take the minimum possible time to execute, reserving more processing cycles than should be necessary helps to ensure that for those data access instructions which take longer to execute the replay mechanism is unlikely to need to be invoked. It has been found that such an approach far from degrading the overall performance of the data processing apparatus actually results in improved performance.

In embodiments, the number of reserved processing cycles is determined to be a number of processing cycles which would enable at least one more than the first plurality of data items to be transferred in those reserved processing cycles.

In embodiments, the number of reserved processing cycles is determined to be a number of processing cycles which would enable between one and the second plurality of data items more than the first plurality of data items to be transferred in those reserved processing cycles.

In embodiments, the first plurality of data items comprise ‘x’ data items and the second plurality of data items comprise ‘y’ data items transferred between the registers and the memory in each processing cycle, where ‘x’ and ‘y’ are integers, and the decode logic is operable in response to receipt of the data access instructions to calculate the number of reserved processing cycles according to the formula:

$$number of reserved processing cycles = 1 + ⌈ \frac{x - 1}{y} ⌉ .$$

Hence, the number of reserved processing cycles is determined to be the number of data items to be transferred minus one, divided by the number of the data items which can be transferred between memory and registers in each processing cycle, with the result rounded-up to the next integer, and then one added. It will be appreciated that ‘x’ and ‘y’ may be the same value. It will be appreciated that where a data access set-up period is required then an additional offset will be required to also be added representative of the time taken to access the first data item.

In embodiments, the data processing apparatus, further comprises a bus operable to transfer data items between registers and memory, the bus being operable to support the transfer of the second plurality of data items between the registers and the memory in each processing cycle.

In embodiments, the first plurality of data items and the second plurality of data items are each sequential data items.

Hence, the data access instruction may cause sequential data items to be transferred between the registers and the memory, these sequential data items being typically logically adjacent addresses within the memory. Typically, sequential data items may be, for example, adjacent data items within a cache line or within a row in main memory.

In embodiments, the data processing apparatus is a pipelined data processing apparatus and the decode logic is operable for each pipelined stage to determine a number of reserved processing cycles to be reserved for the execution of the data access instruction.

Accordingly, each pipelined stage may be reserved separately for the execution of the data access instruction.

In embodiments, the decode logic is operable in response to receipt of the data access instruction to generate a number of corresponding sequential micro-instructions in each reserved processing cycle.

Hence, the data access instruction may be an instruction which causes multiple data items to be transferred. The decode logic is operable to generate a single micro-instruction which causes each of these data items to be transferred.

In embodiments, in the event that the data access is an aligned data access then the decode logic is operable to generate a micro-instruction which causes at least one of the first plurality of data items to be transferred between the registers and the memory in each except the last reserved processing cycle.

Hence, in the event that the data access is aligned and therefore results in the maximum number of being transferred in each processing cycle, all the data items will be transferred prior to the last reserved processing cycle. Accordingly, no data items need be transferred in that last reserved processing cycle.

In embodiments, a null instruction is generated in the last processing cycle which causes no data items to be transferred between the registers and the memory in the last reserved processing cycle.

In embodiments, in the event that the data access is an unaligned data access then the decode logic is operable to generate a micro-instruction which causes at least one of the first plurality of data items to be transferred between the registers and the memory in each reserved processing cycle.

Hence, in the event that the data access is unaligned and therefore results in less than the maximum number of being transferred in the first reserved processing cycle, not all the data items will be transferred prior to the last reserved processing cycle. Accordingly, data items will need be transferred in each reserved processing cycle.

In embodiments, the data processing apparatus further comprises buffer logic operable to store data values to enable only aligned data accesses to be made to the memory in each processing cycle.

Hence, in the event that the data access instruction is associated with an unaligned address, the provision of the buffer logic enables unaligned data to be temporarily stored to enable only aligned data accesses to the memory to occur.

In embodiments, the data processing apparatus is operable to determine, prior to each instruction being issued for execution, when resources associated with that instruction are predicted to be available for use by succeeding instructions, the data processing apparatus further comprising: scoreboard logic operable to store an indication of when resources associated with an instruction to be issued are predicted to be available for use by succeeding instructions based on the number of reserved processing cycles.

In embodiments, the data access instruction is one of a load multiple and a store multiple instruction. The data access instruction may also include one of a double word store and a double word load.

Viewed from a second aspect, the present invention provides a method of executing a data access instruction which causes a first plurality of data items to be transferred between registers and memory of a data processing apparatus, the data processing apparatus being operable to transfer a second plurality of data items between the registers and the memory in each processing cycle, the method comprising the steps of: in response to receipt of one of the data access instructions, determining a number of reserved processing cycles to be reserved for the execution of the data access instruction, the number of reserved processing cycles being determined to be a number of processing cycles which would enable greater than the first plurality of data items to be transferred in those reserved processing cycles.

Viewed from a third aspect, the present invention provides a data processing apparatus operable to execute a data access instruction which causes a first plurality of data items to be transferred between registers and memory, the first plurality of data items comprising ‘x’ data items, the data processing apparatus being operable to transfer a second plurality of data items between the registers and the memory in each processing cycle, the second plurality of data items comprising ‘y’ data items, wherein ‘x’ and ‘y’ are both integers, the data processing apparatus comprising: decode means operable in response to receipt of one of the data access instruction to determine a number of reserved processing cycles to be reserved for the execution of the data access instruction, the number of reserved processing cycles being calculated according to the formula:

$$number of reserved processing cycles = 1 + ⌈ \frac{x - 1}{y} ⌉ .$$

### BRIEF DESCRIPTION OF THE DRAWINGS

FIG. 1 illustrates a data processing apparatus according to an embodiment of the present invention;

FIG. 2 illustrates the operation of the data processing apparatus when executing a load multiple instruction for four registers with an aligned starting address;

FIG. 3 illustrates the operation of the data processing apparatus when executing a load multiple instruction for four registers with an unaligned starting address;

FIG. 4 illustrates the operation of the data processing apparatus when executing a load multiple instruction for five registers with an aligned starting address;

FIG. 5 illustrates the operation of the data processing apparatus when executing a load multiple instruction for five registers with an unaligned starting address;

FIG. 6 illustrates the operation of the data processing apparatus when executing a store multiple instruction for four registers with an aligned starting address;

FIG. 7 illustrates the operation of the data processing apparatus when executing a store multiple instruction for four registers with an unaligned starting address;

FIG. 8 illustrates the operation of the data processing apparatus when executing a store multiple instruction for five registers with an aligned starting address; and

FIG. 9 illustrates the operation of the data processing apparatus when executing a store multiple instruction for five registers with an unaligned starting address.

### DESCRIPTION OF PREFERRED EMBODIMENTS

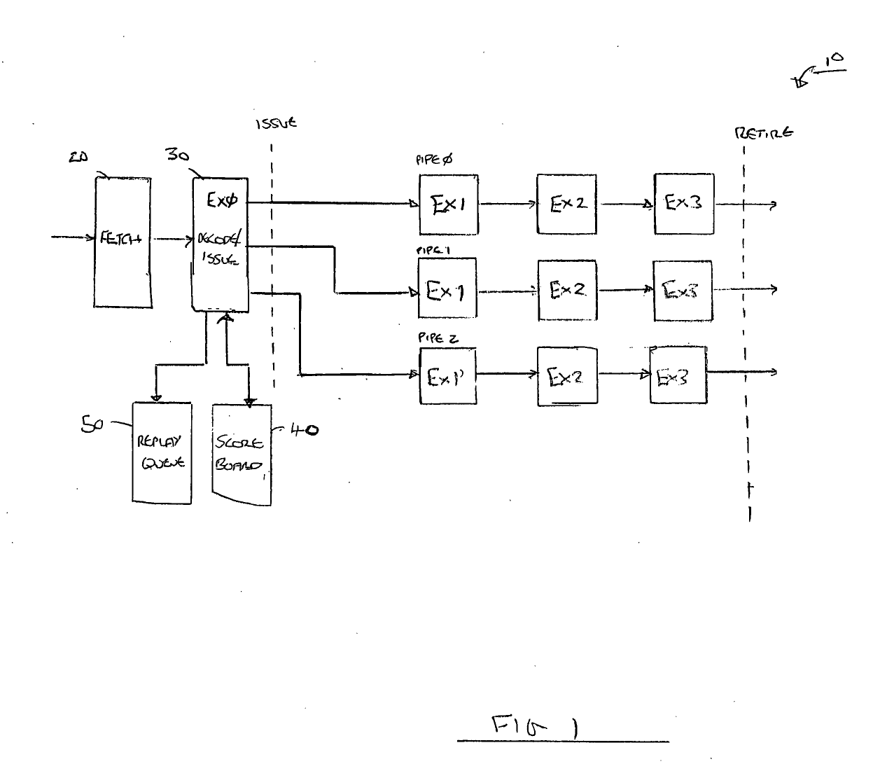

FIG. 1 illustrates a data processing apparatus, generally 10, according to an embodiment of the present invention. The data processing apparatus 10 is a super-scalar statically-scheduled data processing apparatus. The data processing apparatus 10 has, in this example, three parallel pipelines (pipe 0, pipe 1 and pipe 2) to which instructions may be issued concurrently for execution. Generally, pipe 0 is arranged to execute the oldest instruction, whilst pipe 1 executes the youngest instruction. Generally, pipe 2 is a memory system pipe.

The data processing apparatus 10 has fetch logic 20 which fetches instructions to be processed. The fetch logic 20 passes the fetched instructions to the decode/issue stage 30 for decoding and for issuing of the decoded instructions to subsequent stages in the pipeline.

The decode/issue stage 30 interacts with a scoreboard 40 which stores an indication of the resources currently allocated to other instructions which have already been issued. The scoreboard 40 provides an indication of when the resources (such as registers, processing units, memory locations, etc.) will be available for use by subsequent instructions.

The information relating to the allocation of the resources is predicted by the decode/issue stage 30 when issuing instructions, based on the instruction being issued. For example, when an instruction is to be issued which will cause the contents of a register to be changed, the decode/issue stage 30 will make a prediction of which future processing cycle the contents of the registers will be available for use by succeeding instructions. For example, if the instruction is a shift instruction for which it is expected that the source operand of the instruction will have been read and/or the destination operand of the instruction is expected to have been calculated within two processing cycles of the instruction being issued, then the scoreboard 40 may be updated to indicate that the resources associated with the shift instruction will be available in two processing cycles. Similarly, if the instruction is a store instruction then the scoreboard 40 may be updated to indicate register(s) associated with that store instruction will be available in four processing cycles.

Accordingly, the scoreboard 40 can readily provide an indication of which registers, processing units, locations in memory or other items or resources associated with executing instructions have already been pre-assigned to existing instructions being executed in the pipeline and provide an indication of when these items will become available.

Hence, the decode/issue stage 30, upon receipt of an instruction to be issued, will refer to the scoreboard 40 in order to determine whether there is any dependency between the instruction to be issued and any instructions that have been issued and which may be currently in the pipeline. For example, if the instruction received by the decode/issue stage 30 is an add instruction which uses the contents of the register R1 and R2 and stores the result in R3, then the decode/issue stage 30 will refer to the scoreboard 40 to determine whether registers R1, R2 and R3 are currently assigned to other instructions. The decode/issue stage 30 will then prevent the issue of the instruction into the pipeline until an appropriate time when the required resources will become available at the time needed by that instruction (it will be appreciated that this need not necessarily be the cycle during which the earlier instruction is predicted to retire but may be an earlier cycle when the data associated with those registers is predicted to be available). In this way, instructions are processed in order and it is possible to assume that once an instruction has been issued all the data and resources it requires to be able to execute correctly should be available when required.

When issuing the instruction, the decode/issue stage 30 will update the scoreboard 40 with the prediction of when the resources associated with that instruction will be available to subsequent instructions. For example, in the event that the instruction being issued is a load instruction from a memory address, the decode/issue stage 30 may update the scoreboard 40 to indicate that the destination register will have the result of the operation in, for example, four clock cycles.

However, it will be appreciated that the information stored in the scoreboard 40 is simply a prediction of when the resources are expected to be available. In reality, it is possible that, in certain circumstances, the resources will not be updated and made available within the time that was predicted. Accordingly, when this occurs, the data used by subsequent instructions may be invalid. Hence, a replay queue 50 is provided which is utilised to recover from this situation.

The reply queue 50 stores an indication of all the instructions currently issued for execution. Once each issued instruction has been confirmed as validly completing, the results of that instruction are committed and the instruction is said to retire. Retired instructions are removed from the reply queue 50. Hence, the replay queue 50 provides an indication of all the instructions which have not yet been fully executed. This replay queue 50 can be used to effectively reconstruct the state of the data processing apparatus in the event that an error occurs during the execution of any issued instructions.

Should the prediction of when resources associated with an instruction are expected to be available be incorrect, the data processing apparatus 10 will detect at system level that an error has occurred and that instruction will not be confirmed to have validly executed, its results will not be committed and the instruction will not be retired.

A replay operation will be initiated in which the issued instructions are flushed from the pipeline without updating any resources and the sequence of instructions is replayed using the instructions in the reply queue 50.

As before, as each replayed instruction is issued for execution, the contents of the scoreboard logic 40 will be updated. In this way, it is possible to schedule the issuing of instructions into the pipeline in order to the maximise performance and throughput of the data processing apparatus.

It will be appreciated that the prediction of when resources associated with any particular instruction will become available needs to be done as accurately as possible. If the prediction is overly optimistic, then the resources may not be available when required which will require a replay operation to be performed. As mentioned previously, performing the reply operation is not trivial and has a marked impact on performance.

Data access instructions are instructions for which number of processing cycles required to complete the data access can vary from instruction to instruction. This is particularly the case where the data access instruction causes a plurality of sequential data items to be accessed. Hence, the number of processing cycles which need to be reserved can also vary. This variation occurs because the data access can be either aligned or unaligned. An aligned data access occurs when the memory address causes the first data value in a cache line or a main memory row to be accessed, otherwise the access is said to be unaligned.

For aligned data accesses, the maximum number of data items supported by the bandwidth of the bus coupling the registers and memory will be transferred in each processing cycle. In the first processing cycle in which data is transferred, the first requested data item will be transferred together with a number of further sequential data items. Hence, if it is known that the data access will be aligned, and it is known how many sequential data items are to be transferred, together with the number of data items that can be transferred in each processing cycle between the registers and memory, then an accurate prediction can be made of how many processing cycles need to be reserved for that data access instruction.

For unaligned data accesses, less than the maximum number of data items supported by the bandwidth of the bus coupling the registers and memory will be transferred in each processing cycle. This is because the address of the first requested data item is unaligned. Accordingly, in the first processing cycle in which data is transferred, the first requested data item will be transferred together with possibly a number of further sequential data items. In subsequent processing cycles the maximum number of data items supported by the bus may be transferred, with the final processing cycle transferring the balance of requested data items. Hence, if it is known that the data access will be unaligned, and it is known how many sequential data items are to be transferred, together with the number of data items that can be transferred in each processing cycle between the registers and memory, then an accurate prediction can also be made of how many processing cycles need to be reserved for that data access instruction.

However, the address of the data access instruction will not be generated until the after the instruction has been issued and hence, the determination of whether the data access is aligned or unaligned is not know at the time the scoreboard logic 40 needs to be updated.

Accordingly, the decode/issue stage 30 makes a determination, for data access instructions, of the number of processing cycles to be reserved for the execution of the data access instruction. Typically, the data access instruction is decoded by the decode/issue stage 30 into a number of micro-instructions, each of which cause a data access of a number of data items and the number of processing cycles reserved for the execution of each micro-instruction is determined. The number of processing cycles reserved is calculated to be greater that which would enable greater than the required number of data items to be transferred in those reserved processing cycles, according to the formula:

$$number of reserved processing cycles = 1 + ⌈ \frac{x - 1}{y} ⌉ ,$$

where ‘x’ data items are to be transferred by that instruction, and ‘y’ data items can be transferred between the registers and the memory in each processing cycle, where ‘x’ and ‘y’ are integers which may have the same value.

As will be explained in more detail below, through this approach a reasonably accurate prediction can be made of the number of processing cycles to be reserved for that data access instruction. By making the prediction slightly pessimistic, the chances of a replay having to be activated can be minimised even when an unaligned data access occurs, whilst the amount of delay introduced to any aligned data access is also minimised to a maximum of one processing cycle.

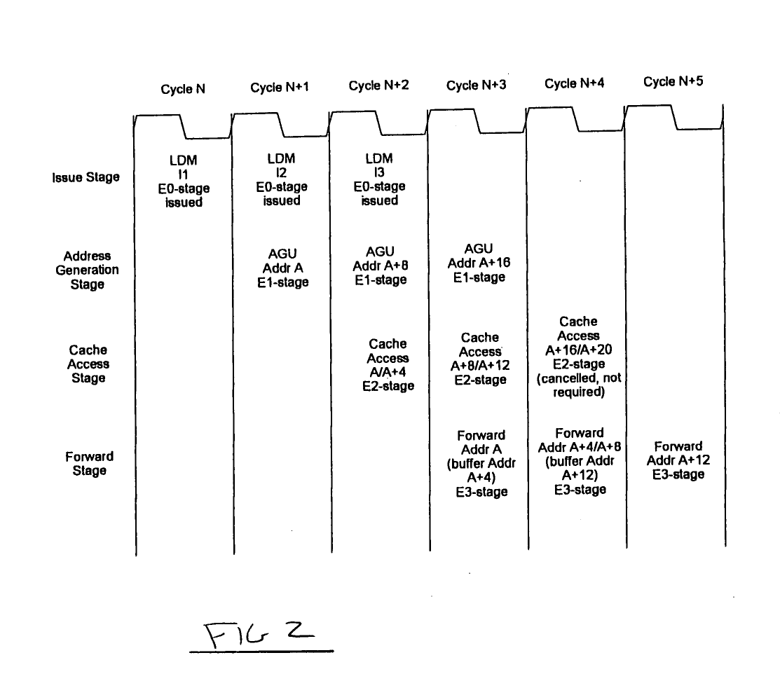

FIG. 2 illustrates the operation of the data processing apparatus when executing a load multiple instruction for four registers with an aligned starting address. In this example, the number of data items to be transferred is four and the data bus coupling the registers and memory is operable to support the transfer of up to two data items in each processing cycle.

The decode/issue stage 30 determines that each pipelined stage used in the execution of the load multiple instruction will be reserved for three processing cycles, during which three corresponding micro-instructions will be executed.

The first micro-instruction, which causes the data values at address A and A+4 to be accessed, is issued by the decode/issue stage 30 in cycle N. Thereafter, in cycle N+1, the address generation stage generates an address A. In cycle N+2, the cache access stage causes a cache access of the data items stored at address A and at address A+4. In cycle N+3, the forward stage returns the data item stored at address A is, whilst the data item at address A+4 is buffered.

The second micro-instruction, which causes the data values at address A+8 and A+12 to be accessed, is issued by the decode/issue stage 30 in cycle N+1. Thereafter, in cycle N+2, the address generation stage generates an address A+8. In cycle N+3, the cache access stage causes a cache access of the data items stored at address A+8 and at address A+12. In cycle N+4, the forward stage returns the data items stored at address A+4 and A+8, whilst the data item at address A+12 is buffered.

The third micro-instruction, which causes the data values at address A+16 and A+20 to be accessed, is issued by the decode/issue stage 30 in cycle N+2 (the last reserved cycle of that data access instruction for that pipelined stage). Thereafter, in cycle N+3 (also the last reserved cycle of that data access instruction for that pipelined stage), the address generation stage generates an address A+16. In cycle N+4 (also the last reserved cycle of that data access instruction for that pipelined stage), the cache access stage cancels the data access because all the required data items have already been accessed. In cycle N+5 (also the last reserved cycle of that data access instruction for that pipelined stage), the forward stage returns the data item stored at address A+12.

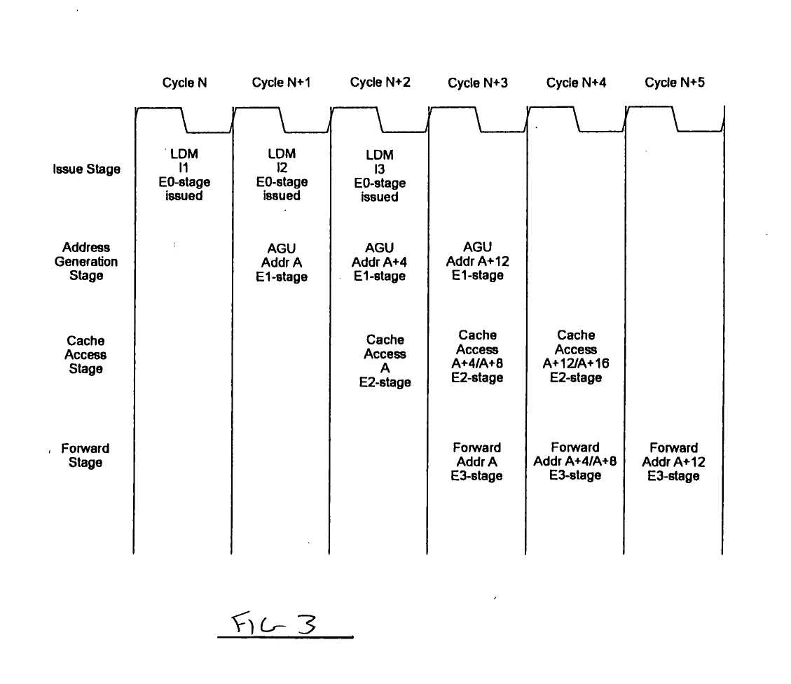

FIG. 3 illustrates the operation of the data processing apparatus when executing a load multiple instruction for four registers with an unaligned starting address. In this example, the number of data items to be transferred is four and the data bus coupling the registers and memory is operable to support the transfer of up to two data items in each processing cycle.

The decode/issue stage 30 determines that each pipelined stage used in the execution of the load multiple instruction will be reserved for three processing cycles, during which three corresponding micro-instructions will be executed.

The first micro-instruction, which causes the data values at address A to be accessed, is issued by the decode/issue stage 30 in cycle N. Thereafter, in cycle N+1, the address generation stage generates an address A. In cycle N+2, the cache access stage causes a cache access of the data item stored at address A. In cycle N+3, the forward stage returns the data item stored at address A.

The second micro-instruction, which causes the data values at address A+4 and A+8 to be accessed, is issued by the decode/issue stage 30 in cycle N+1. Thereafter, in cycle N+2, the address generation stage generates an address A+4. In cycle N+3, the cache access stage causes a cache access of the data items stored at address A+4 and at address A+8. In cycle N+4, the forward stage returns the data items stored at address A+4 and A+8.

The third micro-instruction, which causes the data values at address A+12 and A+16 to be accessed, is issued by the decode/issue stage 30 in cycle N+2 (the last reserved cycle of that data access instruction for that pipelined stage). Thereafter, in cycle N+3 (also the last reserved cycle of that data access instruction for that pipelined stage), the address generation stage generates an address A+12. In cycle N+4 (also the last reserved cycle of that data access instruction for that pipelined stage), the cache access stage causes a cache access of the data items stored at address A+12 and at address A+16. In cycle N+5 (also the last reserved cycle of that data access instruction for that pipelined stage), the forward stage returns the data item stored at address A+12.

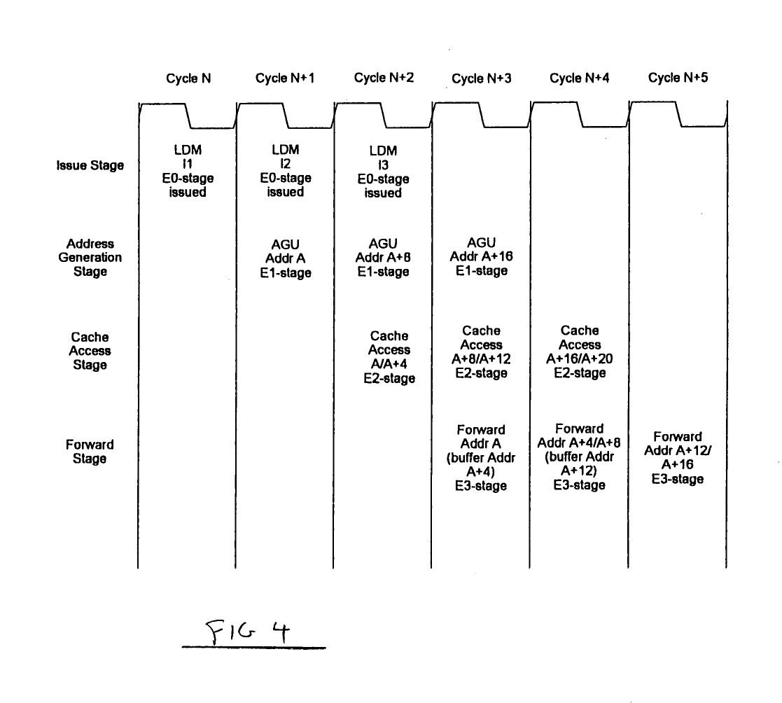

FIG. 4 illustrates the operation of the data processing apparatus when executing a load multiple instruction for five registers with an aligned starting address. In this example, the number of data items to be transferred is five and the data bus coupling the registers and memory is operable to support the transfer of up to two data items in each processing cycle.

The decode/issue stage 30 determines that each pipelined stage used in the execution of the load multiple instruction will be reserved for three processing cycles, during which three corresponding micro-instructions will be executed.

The first micro-instruction, which causes the data values at address A and A+4 to be accessed, is issued by the decode/issue stage 30 in cycle N. Thereafter, in cycle N+1, the address generation stage generates an address A. In cycle N+2, the cache access stage causes a cache access of the data items stored at address A and at address A+4. In cycle N+3, the forward stage returns the data item stored at address A is, whilst the data item at address A+4 is buffered.

The second micro-instruction, which causes the data values at address A+8 and A+12 to be accessed, is issued by the decode/issue stage 30 in cycle N+1. Thereafter, in cycle N+2, the address generation stage generates an address A+8. In cycle N+3, the cache access stage causes a cache access of the data items stored at address A+8 and at address A+12. In cycle N+4, the forward stage returns the data items stored at address A+4 and A+8, whilst the data item at address A+12 is buffered.

The third micro-instruction, which causes the data values at address A+16 and A+20 to be accessed, is issued by the decode/issue stage 30 in cycle N+2 (the last reserved cycle of that data access instruction for that pipelined stage). Thereafter, in cycle N+3 (also the last reserved cycle of that data access instruction for that pipelined stage), the address generation stage generates an address A+16. In cycle N+4 (also the last reserved cycle of that data access instruction for that pipelined stage), the cache access stage causes a cache access of the data items stored at address A+16 and at address A+20. In cycle N+5 (also the last reserved cycle of that data access instruction for that pipelined stage), the forward stage returns the data item stored at address A+12 and A+16, with the data item stored at address A+20 being discarded.

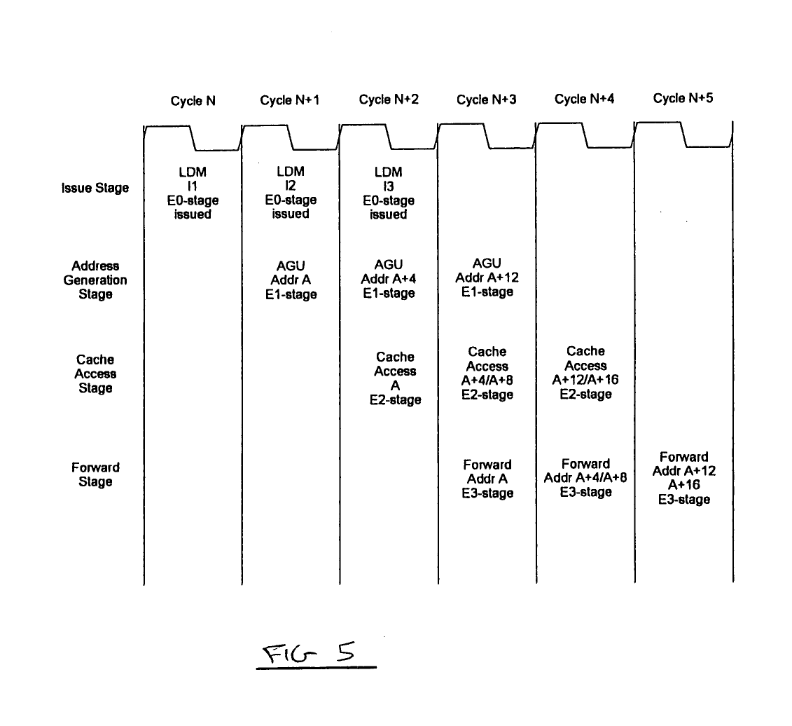

FIG. 5 illustrates the operation of the data processing apparatus when executing a load multiple instruction for five registers with an unaligned starting address. In this example, the number of data items to be transferred is five and the data bus coupling the registers and memory is operable to support the transfer of up to two data items in each processing cycle.

The decode/issue stage 30 determines that each pipelined stage used in the execution of the load multiple instruction will be reserved for three processing cycles, during which three corresponding micro-instructions will be executed.

The first micro-instruction, which causes the data values at address A to be accessed, is issued by the decode/issue stage 30 in cycle N. Thereafter, in cycle N+1, the address generation stage generates an address A. In cycle N+2, the cache access stage causes a cache access of the data item stored at address A. In cycle N+3, the forward stage returns the data item stored at address A.

The second micro-instruction, which causes the data values at address A+4 and A+8 to be accessed, is issued by the decode/issue stage 30 in cycle N+1. Thereafter, in cycle N+2, the address generation stage generates an address A+4. In cycle N+3, the cache access stage causes a cache access of the data items stored at address A+4 and at address A+8. In cycle N+4, the forward stage returns the data items stored at address A+4 and A+8.

The third micro-instruction, which causes the data values at address A+12 and A+16 to be accessed, is issued by the decode/issue stage 30 in cycle N+2 (the last reserved cycle of that data access instruction for that pipelined stage). Thereafter, in cycle N+3 (also the last reserved cycle of that data access instruction for that pipelined stage), the address generation stage generates an address A+12. In cycle N+4 (also the last reserved cycle of that data access instruction for that pipelined stage), the cache access stage causes a cache access of the data items stored at address A+12 and at address A+16. In cycle N+5 (also the last reserved cycle of that data access instruction for that pipelined stage), the forward stage returns the data items stored at address A+12 and A+16.

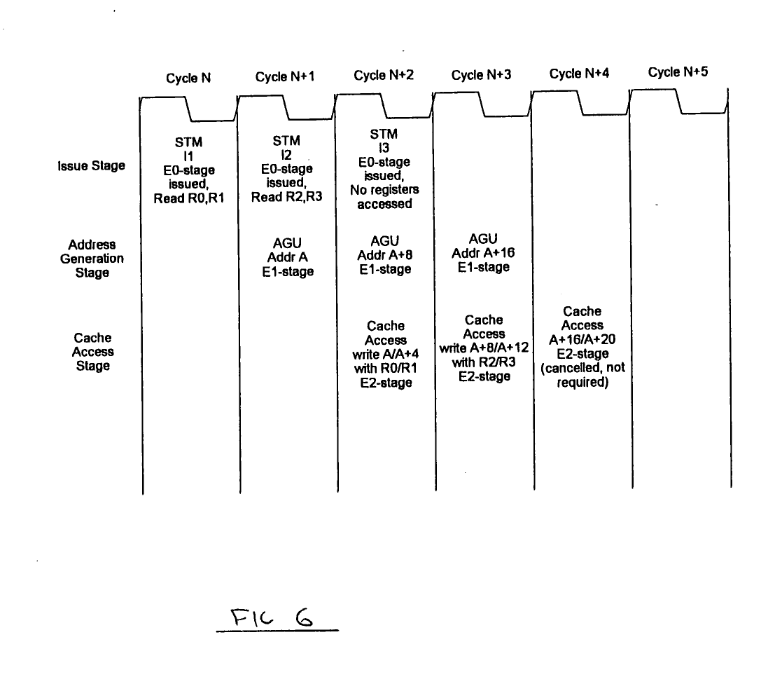

FIG. 6 illustrates the operation of the data processing apparatus when executing a store multiple instruction for four registers with an aligned starting address. In this example, the number of data items to be transferred is four and the data bus coupling the registers and memory is operable to support the transfer of up to two data items in each processing cycle.

The decode/issue stage 30 determines that each pipelined stage used in the execution of the store multiple instruction will be reserved for three processing cycles, during which three corresponding micro-instructions will be executed.

The first micro-instruction, which causes the data values stored in registers R0 and R1 to be accessed, is issued by the decode/issue stage 30 in cycle N. Thereafter, in cycle N+1, the address generation stage generates an address A. In cycle N+2, the cache access stage causes a cache write of the data values stored at R0 and R1 to addresses A and A+4 respectively.

The second micro-instruction, which causes the data values stored in registers R2 and R3 to be accessed, is issued by the decode/issue stage 30 in cycle N+1. Thereafter, in cycle N+2, the address generation stage generates an address A+8. In cycle N+3, the cache access stage causes a cache write of the data values stored at R2 and R3 to addresses A+8 and A+12 respectively.

The third micro-instruction is issued by the decode/issue stage 30 in cycle N+2 which causes no registers to be accessed (the last reserved cycle of that data access instruction for that pipelined stage). Thereafter, in cycle N+3 (also the last reserved cycle of that data access instruction for that pipelined stage), the address generation stage generates an address A+16. In cycle N+4 (also the last reserved cycle of that data access instruction for that pipelined stage), the cache access stage cancels the data access because all the required data items have already been accessed.

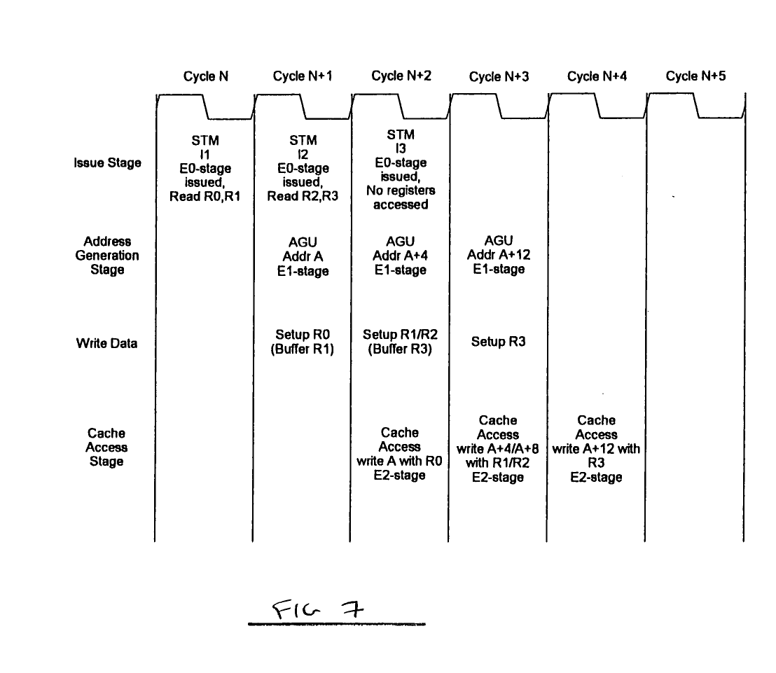

FIG. 7 illustrates the operation of the data processing apparatus when executing a store multiple instruction for four registers with an unaligned starting address. In this example, the number of data items to be transferred is four and the data bus coupling the registers and memory is operable to support the transfer of up to two data items in each processing cycle.

The decode/issue stage 30 determines that each pipelined stage used in the execution of the store multiple instruction will be reserved for three processing cycles, during which three corresponding micro-instructions will be executed.

The first micro-instruction, which causes the data values stored in registers R0 and R1 to be accessed, is issued by the decode/issue stage 30 in cycle N. Thereafter, in cycle N+1, the address generation stage generates an address A and the data item stored in R0 setup to be provided for writing to the memory, whilst the data item stored in R1 is buffered. In cycle N+2, the cache access stage causes a cache write of the data value stored at R0 to address A.

The second micro-instruction, which causes the data values stored in registers R2 and R3 to be accessed, is issued by the decode/issue stage 30 in cycle N+1. Thereafter, in cycle N+2, the address generation stage generates addresses A+4, the data items stored in R1 and R2 are setup to be provided for writing to the memory, whilst the data item stored in R3 is buffered. In cycle N+3, the cache access stage causes a cache write of the data values stored at R1 and R2 to addresses A+4 and A+8 respectively.

The third micro-instruction is issued by the decode/issue stage 30 in cycle N+2 which causes no registers to be accessed (the last reserved cycle of that data access instruction for that pipelined stage). Thereafter, in cycle N+3 (also the last reserved cycle of that data access instruction for that pipelined stage), the address generation stage generates addresses A+12 and A+16 and the data item stored in R3 is setup to be provided for writing to the memory. In cycle N+4 (also the last reserved cycle of that data access instruction for that pipelined stage), the cache access stage causes a cache write of the data value stored at R3 to address A+12.

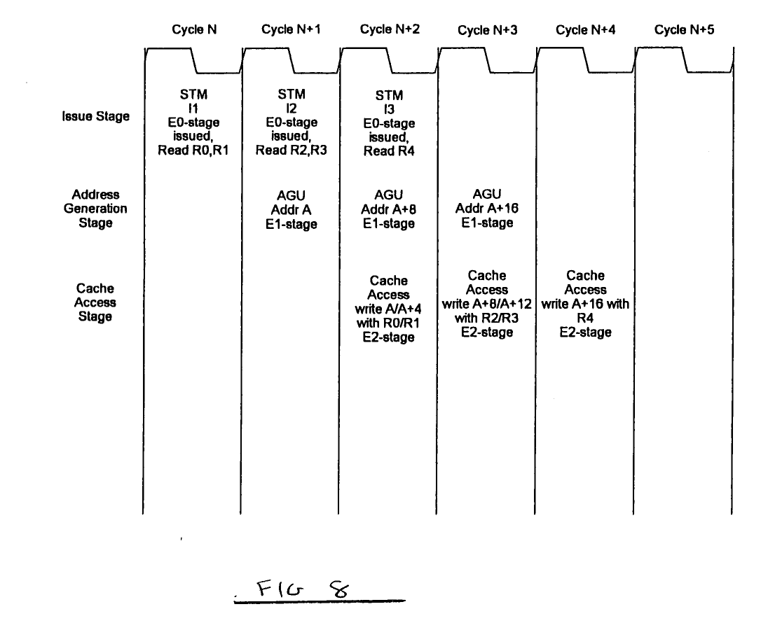

FIG. 8 illustrates the operation of the data processing apparatus when executing a store multiple instruction for five registers with an aligned starting address. In this example, the number of data items to be transferred is five and the data bus coupling the registers and memory is operable to support the transfer of up to two data items in each processing cycle.

The decode/issue stage 30 determines that each pipelined stage used in the execution of the store multiple instruction will be reserved for three processing cycles, during which three corresponding micro-instructions will be executed.

The first micro-instruction, which causes the data values stored in registers R0 and R1 to be accessed, is issued by the decode/issue stage 30 in cycle N. Thereafter, in cycle N+1, the address generation stage generates an address A. In cycle N+2, the cache access stage causes a cache write of the data values stored at R0 and R1 to addresses A and A+4 respectively.

The second micro-instruction, which causes the data values stored in registers R2 and R3 to be accessed, is issued by the decode/issue stage 30 in cycle N+1. Thereafter, in cycle N+2, the address generation stage generates an address A+8. In cycle N+3, the cache access stage causes a cache write of the data values stored at R2 and R3 to addresses A+8 and A+12 respectively.

The third micro-instruction is issued by the decode/issue stage 30 in cycle N+2 which causes register R4 to be accessed (the last reserved cycle of that data access instruction for that pipelined stage). Thereafter, in cycle N+3 (also the last reserved cycle of that data access instruction for that pipelined stage), the address generation stage generates an address A+16. In cycle N+4 (also the last reserved cycle of that data access instruction for that pipelined stage), the cache access stage causes a cache write of the data value stored at R4 to address A+16.

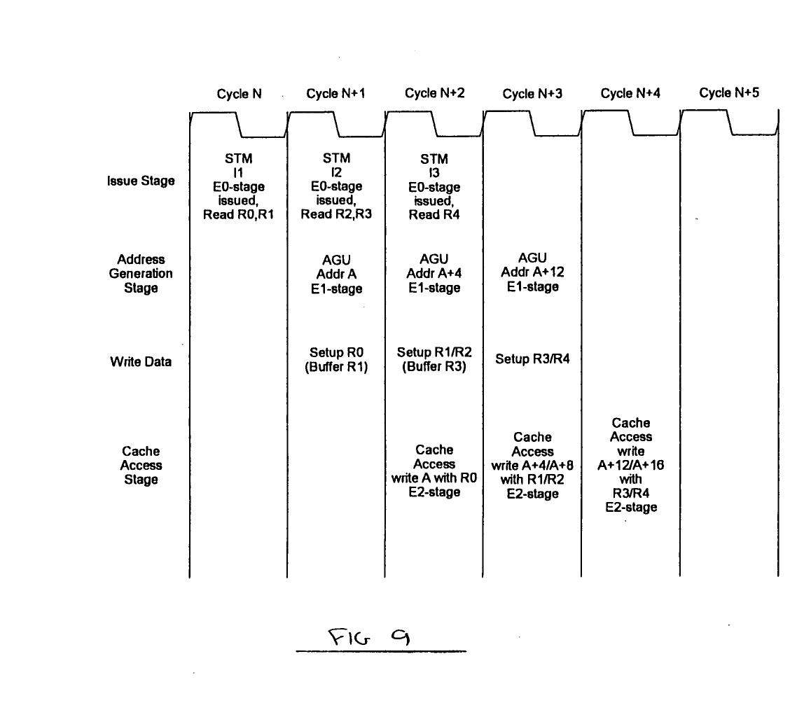

FIG. 9 illustrates the operation of the data processing apparatus when executing a store multiple instruction for five registers with an unaligned starting address. In this example, the number of data items to be transferred is five and the data bus coupling the registers and memory is operable to support the transfer of up to two data items in each processing cycle.

The decode/issue stage 30 determines that each pipelined stage used in the execution of the load multiple instruction will be reserved for three processing cycles, during which three corresponding micro-instructions will be executed.

The first micro-instruction, which causes the data values stored in registers R0 and R1 to be accessed, is issued by the decode/issue stage 30 in cycle N. Thereafter, in cycle N+1, the address generation stage generates an address A and the data item stored in R0 setup to be provided for writing to the memory, whilst the data item stored in R1 is buffered. In cycle N+2, the cache access stage causes a cache write of the data value stored at R0 to address A.

The second micro-instruction, which causes the data values stored in registers R2 and R3 to be accessed, is issued by the decode/issue stage 30 in cycle N+1. Thereafter, in cycle N+2, the address generation stage generates addresses A+4 and A+8, the data items stored in R1 and R2 are setup to be provided for writing to the memory, whilst the data item stored in R3 is buffered. In cycle N+3, the cache access stage causes a cache write of the data values stored at R1 and R2 to addresses A+4 and A+8 respectively.

The third micro-instruction is issued by the decode/issue stage 30 in cycle N+2 which causes register R4 to be accessed (the last reserved cycle of that data access instruction for that pipelined stage). Thereafter, in cycle N+3 (also the last reserved cycle of that data access instruction for that pipelined stage), the address generation stage generates addresses A+12, and the data items stored in R3 and R4 are setup to be provided for writing to the memory. In cycle N+4 (also the last reserved cycle of that data access instruction for that pipelined stage), the cache access stage causes a cache write of the data values stored at R3 and R4 to addresses A+12 and A+16 respectively.

Whilst the above examples have been illustrated with reference to a bus which supports two data items being transferred in each processing cycle, it will be appreciated that the bus could be arranged to support the transfer of any number of data items in each processing cycle. Also, whilst the above examples have been illustrated with reference to instructions which support four and five data items being transferred, it will be appreciated that instructions could require any number of data items to be transferred.

It will be appreciated that through this approach, the number of processing cycles reserved is greater than that which may be ideally necessary to support the data access instruction. Whilst this may have a slight performance impact on data access instructions which take the minimum possible time to execute, reserving more processing cycles than should be necessary helps to ensure that for those data access instructions which take longer to execute the replay mechanism is unlikely to need to be invoked. Such an approach results in improved performance of the data processing apparatus.

Although a particular embodiment of the invention has been described herewith, it would be apparent that the invention is not limited thereto, and that many modifications and additions may be made in the scope of the invention. For example, various combinations of the features of the following dependent claims could be made with features of the independent claims without departing from the scope of the present invention.

We claim:

1. A data processing apparatus operable to execute a data access instruction which causes a first plurality of data items to be transferred between registers and memory, the data processing apparatus being operable to transfer a second plurality of data items between said registers and said memory in each processing cycle, said data processing apparatus comprising:
decode logic operable in response to receipt of one of said data access instruction to determine a number of reserved processing cycles to be reserved for the execution of said data access instruction, said number of reserved processing cycles being determined to be a number of processing cycles which would enable greater than said first plurality of data items to be transferred in those reserved processing cycles.

2. The data processing apparatus as claimed in claim 1, wherein said number of reserved processing cycles is determined to be a number of processing cycles which would enable at least one more than said first plurality of data items to be transferred in those reserved processing cycles.

3. The data processing apparatus as claimed in claim 1, wherein said number of reserved processing cycles is determined to be a number of processing cycles which would enable between one and the second plurality of data items more than said first plurality of data items to be transferred in those reserved processing cycles.

4. The data processing apparatus as claimed in claim 1, wherein said first plurality of data items comprise ‘x’ data items and said second plurality of data items comprise ‘y’ data items transferred between said registers and said memory in each processing cycle, where ‘x’ and ‘y’ are integers, and said decode logic is operable in response to receipt of said data access instructions to calculate said number of reserved processing cycles according to the formula:
$$number of reserved processing cycles = 1 + ⌈ \frac{x - 1}{y} ⌉ .$$

5. The data processing apparatus as claimed in claim 1, further comprising a bus operable to transfer data items between registers and memory, said bus being operable to support the transfer of said second plurality of data items between said registers and said memory in each processing cycle.

6. The data processing apparatus as claimed in claim 1, wherein said first plurality of data items and said second plurality of data items are each sequential data items.

7. The data processing apparatus as claimed in claim 1, wherein said data processing apparatus is a pipelined data processing apparatus and said decode logic is operable for each pipelined stage to determine a number of reserved processing cycles to be reserved for the execution of said data access instruction.

8. The data processing apparatus as claimed in claim 1, wherein said decode logic is operable in response to receipt of said data access instruction to generate a number of corresponding sequential micro-instructions in each reserved processing cycle.

9. The data processing apparatus as claimed in claim 8, wherein in the event that said data access is an aligned data access then said decode logic is operable to generate a micro-instruction which causes at least one of said first plurality of data items to be transferred between said registers and said memory in each except the last reserved processing cycle.

10. The data processing apparatus as claimed in claim 8, wherein a null instruction is generated in said last processing cycle which causes no data items to be transferred between said registers and said memory in said last reserved processing cycle.

11. The data processing apparatus as claimed in claim 8, wherein in the event that said data access is an unaligned data access then said decode logic is operable to generate a micro-instruction which causes at least one of said first plurality of data items to be transferred between said registers and said memory in each reserved processing cycle.

12. The data processing apparatus as claimed in claim 11, further comprising buffer logic operable to store data values to enable only aligned data accesses to be made to said memory in each processing cycle.

13. The data processing apparatus as claimed in claim 1, wherein said data processing apparatus is operable to determine, prior to each instruction being issued for execution, when resources associated with that instruction are predicted to be available for use by succeeding instructions, said data processing apparatus further comprising:
scoreboard logic operable to store an indication of when resources associated with an instruction to be issued are predicted to be available for use by succeeding instructions based on said number of reserved processing cycles.

14. The data processing apparatus as claimed in claim 1, wherein said data access instruction is one of a load multiple and a store multiple instruction.

15. A method of executing a data access instruction which causes a first plurality of data items to be transferred between registers and memory of a data processing apparatus, said data processing apparatus being operable to transfer a second plurality of data items between said registers and said memory in each processing cycle, said method comprising the steps of:
in response to receipt of one of said data access instructions, determining a number of reserved processing cycles to be reserved for the execution of said data access instruction, said number of reserved processing cycles being determined to be a number of processing cycles which would enable greater than said first plurality of data items to be transferred in those reserved processing cycles.

16. The method as claimed in claim 15, wherein said number of reserved processing cycles is determined to be a number of processing cycles which would enable at least one more than said first plurality of data items to be transferred in those reserved processing cycles.

17. The method as claimed in claim 15, wherein said number of reserved processing cycles is determined to be a number of processing cycles which would enable between one and the second plurality of data items more than said first plurality of data items to be transferred in those reserved processing cycles.

18. The method as claimed in claim 15, wherein said first plurality of data items comprise ‘x’ data items and said second plurality of data items comprise ‘y’ data items transferred between said registers and said memory in each processing cycle, where ‘x’ and ‘y’ are integers, and said number of reserved processing cycles is calculated according to the formula:
$$number of reserved processing cycles = 1 + ⌈ \frac{x - 1}{y} ⌉ .$$

19. A data processing apparatus operable to execute a data access instruction which causes a first plurality of data items to be transferred between registers and memory, said first plurality of data items comprising ‘x’ data items, the data processing apparatus being operable to transfer a second plurality of data items between said registers and said memory in each processing cycle, said second plurality of data items comprising ‘y’ data items, wherein ‘x’ and ‘y’ are both integers, said data processing apparatus comprising:
decode means operable in response to receipt of one of said data access instruction to determine a number of reserved processing cycles to be reserved for the execution of said data access instruction, said number of reserved processing cycles being calculated according to the formula:
$$number of reserved processing cycles = 1 + ⌈ \frac{x - 1}{y} ⌉ .$$
